(19) United States
(12) Patent Application Publication
(10) Pub. No.: US 2010/0108038 A1
(43) Pub. Date: May 6, 2010

(54) Fuel Feeding Control Device of Compressed Natural Gas Engine

(75) Inventor: Kyung Wan KANG, Jeonju-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/551,317

(22) Filed: Aug. 31, 2009

(30) Foreign Application Priority Data
Nov. 4, 2008 (KR) 10-2008-0108984

(51) Int. Cl. F02B 43/00; F02D 41/00

(52) U.S. Cl. 123/529; 701/103

(57) ABSTRACT

A fuel feeding control device of a compressed natural gas engine, may include a plurality of storage containers storing compressed natural gas (CNG) and respectively having a fuel inlet and a fuel outlet, a plurality of safety valves respectively connected to the fuel outlet of each storage container, a first line connecting each safety valve to the engine and guiding a flow of the CNG supplied from the respective storage container to the engine, a first valve located adjacent to the storage containers in the first line and controlling a supply of the CNG to the engine, a key switch unit detecting key-on/key-off states, and a controller generating opening/closing signals of the first valve according to the key-on/key-off states, wherein the storage containers are arranged so that the safety valves disposed at each fuel outlet of adjacent storage containers are positioned in opposite locations each other.

### CROSS-REFERENCE TO RELATED APPLICATION

The present application claims priority to Korean Patent Application No. 10-2008-0108984 filed on Nov. 4, 2008, the entire contents of which are incorporated herein for all purposes by this reference.

### BACKGROUND OF THE INVENTION

1. Field of the Invention

The present invention relates to a fuel line of an engine. More particularly, the present invention relates to a fuel feeding control device of a compressed natural gas engine.

2. Description of Related Art

Generally, fuels used for an engine of vehicles are mainly gasoline and diesel. However, recently, various fuels have been developed because of the necessity for alternative fuels and clean fuels considering exhaustion of resources and environmental pollution.

CNG (compressed natural gas) among the alternative fuels has been put to practical use because of its clean burn. The CNG is compressed to a high pressure of 3000 psi to 3600 psi, and is stored in a storage container. The CNG has been used for some large bus engines because the octane number of the CNG is about 120. Smoke and noise can be reduced by using the CNG as a fuel for bus engines. Therefore, the CNG is an eco-friendly fuel because air pollution can be reduced when using it.

Liquefied CNG should be compressed because it is typically in a large volume gaseous state at room temperature. Therefore, vehicles using CNG should have a plurality of storage containers for storing the compressed CNG. Also, the layout of each constituent element including a supplying line arrangement and valves is important to supply the CNG supplied from the storage containers to an engine in a stable state. This is because the layout can affect durability of a single part and performance of the engine.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a fuel feeding control device of a compressed natural gas engine having advantages of reducing leakage of compressed natural gas (CNG) through each connecter of fuel feeding lines by improving an arrangement of storage containers storing the CNG and setting up high-pressure blocking valve close to the storage containers, and enhancing stability by suitably controlling the fuel supply according to operation conditions of a vehicle.

In an aspect of the present invention, the fuel feeding control device of a compressed natural gas engine, may include a plurality of storage containers storing compressed natural gas (CNG) and respectively having a fuel inlet and a fuel outlet, a plurality of safety valves respectively connected to the fuel outlet of each storage container, a first line connecting each safety valve to the engine and guiding a flow of the CNG supplied from the respective storage container to the engine, a first valve located adjacent to the storage containers in the first line and controlling a supply of the CNG to the engine, a key switch unit detecting key-on/key-off states, and a controller analyzing a signal corresponding to a location of a key switch input from the key switch unit, and generating opening/closing signals of the first valve according to the key-on/key-off states, the opening signal of the first valve being generated in the key-on state and the closing signal of the first valve being generated in the key-off state, wherein the storage containers are arranged so that the safety valves disposed at each fuel outlet of adjacent storage containers are positioned in opposite locations each other.

The device may further include second lines separately formed from the first line and individually connected to each safety valve such that in case that a safety valve connected to a storage container is operated, the CNG is exhausted from the storage container into the air through a corresponding second line.

The device may further include an engine speed detector detecting a rotational state of the engine, wherein the controller analyzes a signal input from the engine speed detector in the key-on state and generates the opening/closing signals of the first valve corresponding to the rotational state of the engine, and wherein the controller supplies the opening signal to the first valve when the engine is rotated, and supplies the closing signal to the first valve when the engine is stopped.

will The device may further include a filter positioned between the first valve and the engine in the first line and filtering foreign substances contained in the CNG supplied from the storage containers, a second valve positioned between the storage containers and the first valve in the first line, and configured to be opened or closed by an external force so as to control a flow of the CNG to the first valve, a regulator disposed between the filter and the engine to reduce pressure of the CNG so as to supply a decompressed CNG to the engine, a heat exchanger connected to the regulator and heated according to a pressure change in the regulator, a third valve positioned at the engine, and configured to be opened or closed by the controller so as to control an amount of the decompressed CNG supplied from the regulator to the engine, and a fourth valve positioned between the regulator and the third valve and controlling a flow of the decompressed CNG supplied to the third valve.

The device may further include a pressure detector detecting a pressure of the decompressed CNG flowing between the regulator and the fourth valve, and generating a pressure signal corresponding thereto, wherein the controller analyzes the pressure signal input from the pressure detector and supplies opening/closing signals to the fourth valve according to the pressure of the decompressed CNG, and wherein the controller supplies the closing signal to the fourth valve when the detected pressure of the decompressed CNG is lower than or equal to a predetermined pressure.

In another aspect of the present invention, the first valve may include a high-pressure lock-off blocking valve to block off a flow of the CNG in case that a pressure of the CNG supplied to the first valve is higher than a predetermined pressure.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of a fuel feeding control device of compressed natural gas engine according to an exemplary embodiment of the present invention.

FIG. 2 illustrates a connection state of a fuel feeding line of a periphery storage container.

FIG. 3 is a drawing illustrating comparison of arrangements of storage containers.

FIG. 4 is a drawing illustrating comparison of exhaust lines.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

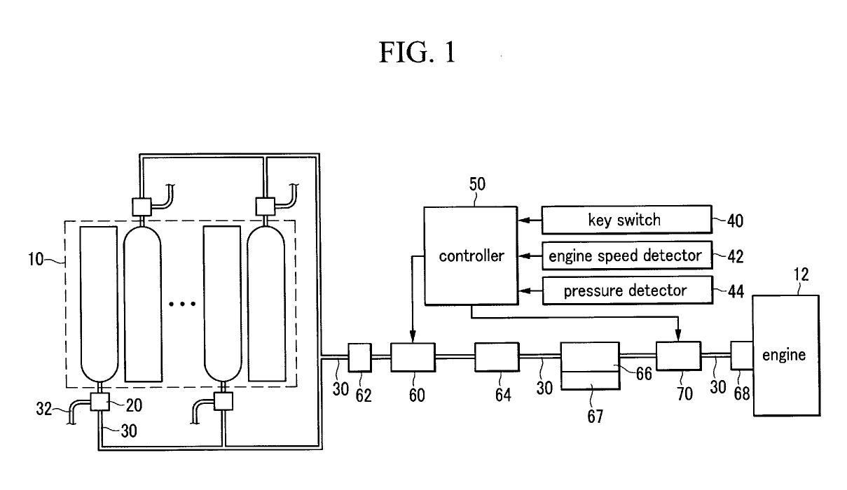

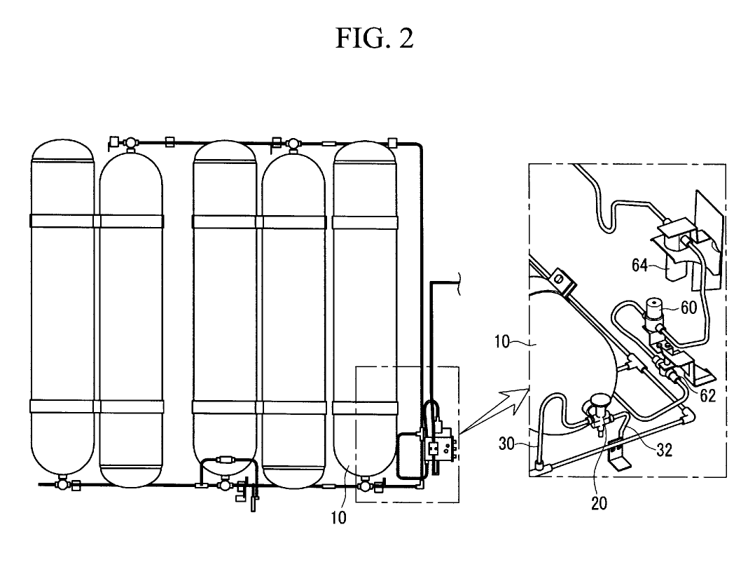

FIG. 1 is a schematic diagram of a fuel feeding control device of a compressed natural gas (CNG) engine according to an exemplary embodiment of the present invention, and FIG. 2 illustrates a connection state of a fuel feeding line of periphery storage containers.

Referring to FIG. 1 and FIG. 2, a fuel feeding control device of the CNG engine according to an exemplary embodiment of the present invention includes a storage container 10, a safety valve 20, a first line 30, a key switch 40, a controller 50, and a first valve 60.

A plurality of the storage containers 10 store the CNG, and they have a fuel inlet and a fuel outlet, respectively. The storage containers 10 store the CNG at a high pressure (about 207 bar), and pressure-feed the CNG to an engine 12.

The safety valve 20 (pressure relief device: PRD) is positioned at the respective fuel outlet of each storage container 10. The safety valve 20 can block an overflow when excessive fuel is emitted by breakage of the first line 30. Also, the safety valve 20 can be operated when the temperature of the storage container 10 is higher than or equal to 110° C. in case of fire, and can prevent the storage container 10 from exploding by over-pressure.

Meanwhile, the plurality of storage containers 10 is arranged so that the safety valves 20 disposed at each fuel outlet of adjacent storage containers 10 are positioned in opposite locations. As described above, the plurality of storage containers 10 are arranged with a zigzag shape.

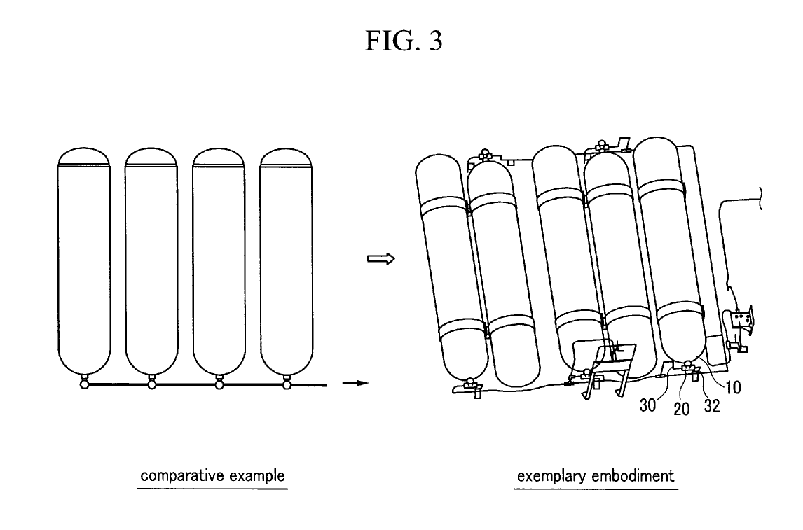

FIG. 3 is a drawing illustrating comparison of arrangements of storage containers. As shown in FIG. 3, storage containers are arranged in a line in contrast to a comparative example.

In this embodiment, explosion caused by increasing the pressure in the storage container 10 before the safety valve 20 is operated in case of local fire at the storage container 10 can be prevented.

A safety device of the storage container 10 releases and the safety valve 20 discharges the CNG from the storage container 10 to the exterior when the temperature of the storage container 10 is higher than or equal to 110° C.

The storage container 10 may be heated from an end portion of the storage container 10 in case of fire, and the storage container 10 may explode before operation of the safety valve 20 by an inner temperature of the storage container 10. If the safety valve 20 is positioned near an area in which the fire occurs, the heat can be detected quickly and thus explosion of the storage container 10 may be prevented.

Herein, a length of a tube line should be same from the fuel inlet of each storage container when a plurality of safety valves is arranged with zigzag shape. Referring to the formula PV=nRT, pressure is correlated to temperature and volume, and therefore a pressure given to the storage container 10 is different according to the length of the tube line. The pressure in each storage container 10 is different according to a difference of temperature when the CNG is input into each storage container 10. For reference, the formula PV=nRT denotes an ideal gas equation, where P denotes pressure, V denotes volume, n denotes a number of moles, R denotes a gas constant, and T denotes absolute temperature.

The first line 30 connects the plurality of safety valves to each other and guides a flow of the CNG supplied from the storage containers 10 to the engine 12. The first line 30 may include tube line.

An exemplary embodiment of the present invention includes a plurality of second lines 32. The second lines 32 are separately connected to each safety valve 20, are separately formed from the first line 30, and are exhausting lines for exhausting the CNG into the air.

The second lines 32 have a function of an exhausting line. The second lines 32 exhaust the CNG into the air from the storage containers 10. The CNG is exhausted through the second lines 32 so as to prevent the storage containers 10 from exploding, even when the storage containers 10 are heated by the outside fire.

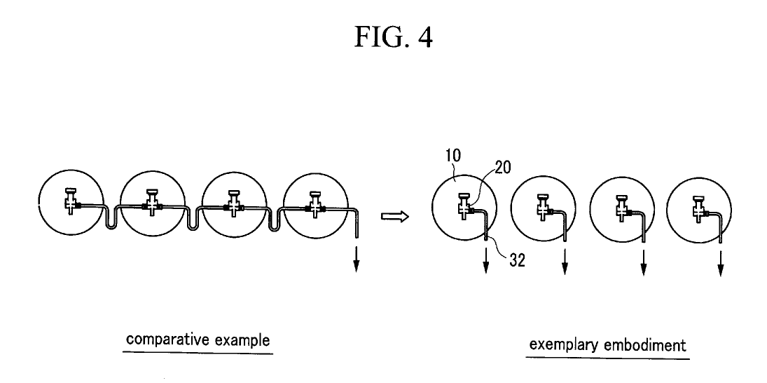

FIG. 4 is a drawing illustrating comparison of exhaust lines.

Referring to FIG. 4, an exhaust line is connected each storage container in contrast to a comparative example. Therefore, the exhaust lines have one or two exhausting outlets when the temperature is increased by fire. According to the comparative example, the CNG in each storage container flows into the exhaust line at the same time, and therefore the exhaust time of the CNG may be delayed when pressure resistance is generated at the exhaust line. If the exhaust time of the CNG is delayed due to the long length of the exhaust line, the storage container may explode because the increase of temperature of the storage container is faster than the exhaust speed of the CNG by operation of the safety valve.

In order to prevent such a phenomenon, in the exemplary embodiment, the length of the exhaust line is shortened, and a plurality of exhausting lines are respectively positioned at each storage container so that the exhaust pressure is reduced. Also, the cost may be lowered due to the shortened length of the exhaust line.

The key switch 40 operates an electrical circuit corresponding to a location thereof, and detects key-on/key-off states

The controller 50 analyzes a signal corresponding to the location of the key switch 40 input from the key switch 40, and generates opening/closing signals of a valve corresponding to the key-on/key-off states,

The controller 50 supplies the opening signal of a valve to the first valve 60 in the key-on state and supplies the closing signal of a valve to the first valve 60 in the key-off state.

The first valve 60 is located close to the storage containers, and controls a supply of the CNG according to the opening/closing signals of a valve received from the controller 50. The first valve 60 includes a high-pressure lock-off valve blocking off flow of the high-pressure CNG.

As shown in FIG. 2, the first valve 60 is mounted close to the storage container 10 and is positioned at the front portion of the vehicle, and therefore leaks of the CNG from the first line 30 through each connector may be reduced. Therefore, stability against CNG leaks may be improved.

Buses have various connectors because the distance between the storage containers 10 and the engine 12 is long. Further, the CNG may leak through the connectors because the pressure of the CNG is very high (e.g., 207 bar).

For this reason, if the first valve 60 is installed close to the storage container 10 and the high-pressure CNG is blocked by the first valve 60, leaks of the CNG may be reduced since the pressure of the CNG is low at the connectors positioned downstream of an outlet of the first valve 60.

An exemplary embodiment of the present invention may include an engine speed detector 42 detecting a rotational state of the engine 12.

In this case, the controller 50 analyzes a signal input from the engine speed detector 42 in the key-on state, and generates the opening/closing signals of a valve corresponding to the rotational state of the engine 12. The controller 50 supplies the opening signal of a valve to the first valve 60 when the engine 12 is rotated, and supplies the closing signal of a valve to the first valve 60 when the engine 12 is stopped.

A filter 64, a second valve 62, a regulator 66, a heat exchanger 67, a third valve 68, and a fourth valve 70 are further positioned at the first line 30.

The filter 64 filters foreign substances contained in the CNG supplied from the storage containers 10.

The second valve 62 is positioned between the storage container 10 and the first valve 60, and opens/closes according to transmission of an external force so as to control flow of the CNG supplied to the first valve 60. The second valve 62 includes a ball valve, and controls flow of the CNG by opening/closing it manually when filter elements are exchanged.

The regulator 66 is connected to the filter 64, reduces pressure of the CNG to a predetermined pressure, and supplies the decompressed CNG to the engine 12. The regulator 66 lowers the CNG pressure from 207 bar to 8 bar.

The heat exchanger 67 is heated according to a pressure change in the regulator 66.

The third valve 68 is positioned at the engine 12, and opens/closes according to control of the controller 50 so as to control amount of CNG supplied from the regulator 66 to the engine 12. The third valve 68 includes a metering valve. The third valve 68 may be a type of injector.

The fourth valve 70 is positioned between the regulator 66 and the third valve 68, and controls flow of the CNG supplied to the third valve 68. The fourth valve 70 includes a low-pressure lock-off valve that blocks flow of the low-pressure CNG.

Meanwhile, an exemplary embodiment of the present invention includes a pressure detector 44 detecting the pressure of the CNG flowing between the regulator 66 and the fourth valve 70, and generates a pressure signal corresponding thereto.

In this case, the controller 50 analyzes the pressure signal input from the pressure detector 44, and supplies opening/closing signals according to the pressure of the CNG to the fourth valve 70. The controller 50 supplies the closing signal to the fourth valve 70 when the detected pressure of the CNG is lower than or equal to a predetermined pressure.

Operation of the fuel feeding control device of a CNG engine according to an exemplary embodiment of the present invention will be described hereinafter with reference to FIG. 1 to FIG. 4.

The fuel feeding control device of the CNG engine according to an exemplary embodiment of the present invention may be applicable to buses using CNG fuel, as structures for improving stability thereof.

First, a plurality of the safety valves positioned respectively at each storage container are arranged with a zigzag shape as shown in FIG. 1 and FIG. 2. The first valve 60 for blocking high pressure is set up close to the storage container 10 at the first line 30 supplying the CNG to the engine 12 by connecting the storage container 10 to the engine 12. Also, the second lines individually connected to each safety valve are provided so as for the CNG to be exhausted.

The CNG exhausted from the storage container 10 is supplied to the engine 12 through the first line 30. The CNG input to the first line 30 flows sequentially to the second valve 62 and the first valve 60.

Opening/closing operations of the first valve 60 are controlled according to the opening/closing signals of a valve supplied from the controller 50. The first valve 60 is opened and closed according to operations of the key-on/key-off. The first valve 60 allows the CNG to be supplied smoothly in the key-on state, and prevents the supply of the CNG in a state in which the engine 12 is stopped, such as the key-off state. The controller 50 supplies the opening signal of a valve generated in the key-on state to the first valve 60, and supplies the closing signal of a valve generated in the key-off state to the first valve 60.

Meanwhile, the controller 50 may control so that the supply of the CNG is blocked off in a predetermined time (2 seconds) when the engine 12 is stopped in the key-on state (in an unexpected circumstance). Therefore, an exemplary embodiment of the present invention may block off the supply of the CNG when the engine 12 is stopped.

Fire may be generated through a heated exhaust line when the supply of the CNG continues when the engine 12 is operated and is then stopped in the key-on state.

In order to solve the problem, the controller 50 analyze a signal input from the engine speed detector 42 in the key-on state and generates the opening/closing signals of a valve corresponding to the rotational state of the engine 12. Therefore, the controller 50 supplies the opening signal of a valve to the first valve 60 when the engine 12 is rotated, and supplies the closing signal of a valve to the first valve 60 when the engine 12 is stopped.

The first valve 60 is opened when the engine 12 is rotated in the key-on state of the vehicle, and guides a flow of the CNG according to the controlling operation as described above. On the contrary, the supply of the CNG is blocked off when the first valve 60 is closed in the key-off state of the vehicle. Also, the first valve 60 is closed when the engine is stopped even in the key-on state of the vehicle, and thus the supply of the CNG is blocked.

The CNG passing through the first valve 60 is filtered by the filter 64 and is supplied to the regulator 66. The pressure of the CNG is reduced to a predetermined pressure through the regulator 66. The decompressed CNG is supplied to the third valve 68 by passing through the fourth valve 70. At this time, the fourth valve 70 blocks off the flow of the CNG supplied to the third valve 68 when the pressure of the CNG is lower than or equal to a predetermined pressure.

Opening/closing operations of the fourth valve 70 are controlled according to the opening/closing signals of a valve supplied from the controller 50. The controller 50 analyzes the pressure signal input from the pressure detector 44, and supplies opening/closing signals according to the pressure of the CNG to the fourth valve 70. The controller 50 supplies the closing signal to the fourth valve 70 when detected pressure of the CNG is lower than or equal to a predetermined pressure.

The CNG is mixed with intake air when the CNG is supplied to the third valve 68 through the fourth valve 70, and the mixed CNG is supplied to the engine 12.

The CNG stored in the storage container 10 is supplied to the engine 12 through a feeding path of the CNG as described above, and is used as fuel.

The fuel feeding control device of CNG engine may prevent explosion caused by an increase of pressure before the safety valve 20 is operated in case of a local fire at the storage container 10.

Also, a valve blocking high pressure is positioned close to the storage container at the fuel supply line, and therefore a leak of the CNG at the fuel supply line through each connector may be reduced, and stability against CNG leaks may be improved.

Also, the length of the exhaust line is shortened, exhaust lines are respectively positioned at each storage container such that the exhaust pressure is reduced, and cost may be lowered due to the shortened length of the exhaust line.

For convenience in explanation and accurate definition in the appended claims, the term “front” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel feeding control device of a compressed natural gas engine, comprising:
a plurality of storage containers storing compressed natural gas (CNG) and respectively having a fuel inlet and a fuel outlet;
a plurality of safety valves respectively connected to the fuel outlet of each storage container;
a first line connecting each safety valve to the engine and guiding a flow of the CNG supplied from the respective storage container to the engine;
a first valve located adjacent to the storage containers in the first line and controlling a supply of the CNG to the engine;
a key switch unit detecting key-on/key-off states; and
a controller analyzing a signal corresponding to a location of a key switch input from the key switch unit, and generating opening/closing signals of the first valve according to the key-on/key-off states, the opening signal of the first valve being generated in the key-on state and the closing signal of the first valve being generated in the key-off state,
wherein the storage containers are arranged so that the safety valves disposed at each fuel outlet of adjacent storage containers are positioned in opposite locations each other.

2. The device of claim 1, further comprising second lines separately formed from the first line and individually connected to each safety valve such that in case that a safety valve connected to a storage container is operated, the CNG is exhausted from the storage container into the air through a corresponding second line.

3. The device of claim 1, further comprising an engine speed detector detecting a rotational state of the engine,
wherein the controller analyzes a signal input from the engine speed detector in the key-on state and generates the opening/closing signals of the first valve corresponding to the rotational state of the engine, and
wherein the controller supplies the opening signal to the first valve when the engine is rotated, and supplies the closing signal to the first valve when the engine is stopped.

4. The device of claim 3, further comprising:
a filter positioned between the first valve and the engine in the first line and filtering foreign substances contained in the CNG supplied from the storage containers;
a second valve positioned between the storage containers and the first valve in the first line, and configured to be opened or closed by an external force so as to control a flow of the CNG to the first valve;
a regulator disposed between the filter and the engine to reduce pressure of the CNG so as to supply a decompressed CNG to the engine;
a heat exchanger connected to the regulator and heated according to a pressure change in the regulator;
a third valve positioned at the engine, and configured to be opened or closed by the controller so as to control an amount of the decompressed CNG supplied from the regulator to the engine; and
a fourth valve positioned between the regulator and the third valve and controlling a flow of the decompressed CNG supplied to the third valve.

5. The device of claim 4, further comprising a pressure detector detecting a pressure of the decompressed CNG flowing between the regulator and the fourth valve, and generating a pressure signal corresponding thereto,
wherein the controller analyzes the pressure signal input from the pressure detector and supplies opening/closing signals to the fourth valve according to the pressure of the decompressed CNG, and
wherein the controller supplies the closing signal to the fourth valve when the detected pressure of the decompressed CNG is lower than or equal to a predetermined pressure.

6. The device of claim 1, wherein the first valve includes a high-pressure lock-off blocking valve to block off a flow of the CNG in case that a pressure of the CNG supplied to the first valve is higher than a predetermined pressure.
